(19) United States
(12) Patent Application Publication
(10) Pub. No.: US 2024/0166485 A1
(43) Pub. Date: May 23, 2024

(54) MOBILE BEVERAGE PACKAGING EQUIPMENT, TRAILER AND METHODS FOR PACKAGING BEVERAGES

(71) Applicant: AGTECH VI, LLC, St. Thomas, VI (US)

(72) Inventor: Angus RITTENBURG, Trumbauersville, PA (US)

(21) Appl. No.: 18/552,729

(22) PCT Filed: Apr. 12, 2022
(86) PCT No.: PCT/US2022/024394

§ 371 Date: Sep. 27, 2023

Related U.S. Application Data
(60) Provisional application No. 63/174,233, filed on Apr. 13, 2021.

(51) Int. Cl. B67C 3/00; B67C 3/06; B67C 3/20

(52) U.S. Cl. CPC B67C 3/008; B67C 3/06; B67C 3/208

(57) ABSTRACT

A mobile beverage packaging system comprising a trailer that is capable of preparing as well as packaging beverages is disclosed. The trailer is self-contained and capable of blending beverage components to prepare a beverage and in turn packaging the beverages and, in one embodiment, preparing and packaging beverages containing an infused composition.

This application claims the benefit of U.S. Application No. 63/174,233, filed Apr. 13, 2021. The disclosure of Application No. 63/174,233 is hereby incorporated by reference.

### FIELD OF THE INVENTION

The subject matter of this invention relates to mobile equipment that is transported to a facility and used for preparing and packaging the beverages at the facility.

### BACKGROUND OF THE INVENTION

Conventional mobile packaging systems are limited to packaging equipment and lack the capability to prepare beverages. This invention solves problems associated with conventional transportable packaging equipment by providing equipment that is useful for preparing and packaging beverages.

### SUMMARY OF THE INVENTION

The instant invention solves problems associated with conventional mobile beverage packaging systems by providing a trailer that is capable of preparing as well as packaging beverages. The trailer is self-contained and capable of blending beverage components to prepare a beverage and in turn packaging the beverages and, in one embodiment, preparing and packaging beverages containing an infused composition.

One embodiment of the invention relates to mobile beverage packaging equipment as well as methods for using the equipment for packaging beverages including beverages comprising at least one infused composition.

One embodiment of the invention relates to mobile beverage preparation and packaging equipment comprising a trailer for transporting the equipment, at least one stationary component and at least one portable component wherein the stationary component is affixed to the trailer and the at least one portable component is removable from the trailer.

One aspect of any combination of the foregoing embodiments wherein the trailer includes a slidable canopy covering the stationary and portable components.

One aspect of any combination of the foregoing embodiments wherein the stationary components comprise at least one member selected from the group consisting of an electrical panel, power generator, chiller and air compressor, product tank, carbonation system, and carbon dioxide storage tanks.

One aspect of any combination of the foregoing embodiments wherein the portable components comprise at least one of a can filler and seamer and optionally a dosing apparatus for introducing an additional compound into the beverage.

One aspect of any combination of the foregoing embodiments wherein the stationary components are used for preparing the beverage.

One aspect of any combination of the foregoing embodiments wherein the portable components are used for packaging the beverage.

One aspect of any combination of the foregoing embodiments wherein the beverage, electricity and compressed air are supplied from at least one of the stationary components to at least one of the portable components.

One aspect of any combination of the foregoing embodiments wherein the beverage, electricity and compressed air are supplied via flexible conduits.

One embodiment of the invention relates to packaging beverages containing an infused composition wherein all activities associated with the infused composition including infusing into a beverage, packaging the infused beverage as well as storing packaged beverages containing the infused composition are all conducted within a defined area (e.g., a defined area or defined enclosed area or defined location all of which are used interchangeably herein).

One aspect of any combination of the foregoing embodiments relating to a method for preparing and packaging carbonated beverages comprising:
i) providing mobile beverage preparation and packaging equipment comprising a trailer for transporting the equipment, at least one stationary component and at least one portable component wherein the stationary component is affixed to the trailer and the at least one portable component is removable from the trailer,
ii) transporting the trailer to a predetermined location,
iii) removing the portable components from the trailer,
iv) preparing the beverage using the stationary components,
v) transferring the beverage to the portable components, and;
vi) packaging the beverage using the portable components.

One aspect of any combination of the foregoing embodiments and further comprising adding a preservative to the prepared beverage.

One aspect of any combination of the foregoing embodiments and further comprising adding at least one additional composition to the beverage after removing the portable components and before packaging the beverage.

One aspect of any combination of the foregoing embodiments and further comprising removing the portable components and positioning the portable components within a defined enclosed location that is different than the predetermined location of the trailer.

One aspect of any combination of the foregoing embodiments wherein the additional composition comprises at least one infused compound.

One aspect of any combination of the foregoing embodiments wherein the portable component comprises a counter pressure can filler.

One aspect of any combination of the foregoing embodiments wherein the beverage comprises less than 2,000 ppb oxygen.

One aspect of any combination of the foregoing embodiments wherein the beverage comprises greater than 2 volumes of carbon dioxide.

The various aspects and embodiments of this disclosure can be used alone or in combinations with each other.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1A is a side elevation view of the inventive trailer.

FIG. 1B is an overhead view of the trailer in open and closed configurations.

FIG. 2A is a side elevation view of the inventive trailer in a partially open configuration with the portable components removed.

FIG. 2B is an overhead view of the inventive trailer in a partially open configuration with the portable components removed.

FIG. 3 is a schematic diagram showing material flow through the packaging equipment for packaging beverages.

Wherever possible, the same reference numbers will be used throughout the drawings to represent the same parts.

### DETAILED DESCRIPTION OF THE INVENTION

The following definitions are provided to illustrate the various aspects and embodiments of this disclosure.

“Packaging” refers to sealing a beverage within a container such as a can, bottle, among other suitable containers. Packaging employs the portable equipment.

“Preparing” refers to using the stationary equipment for combining the ingredients of a beverage. Preparing employs a plurality of individual steps including blending a flavorant into water, carbonation and, in some cases, introducing an additive (or introducing the additive prior to packaging the beverage). The prepared beverage is transferred to the portable equipment for packaging.

“Equipment” refers to stationary and portable equipment on a mobile trailer that is used for packaging beverages.

“Beverage” means a carbonated beverage comprising carbonated water, flavoring and optionally one or more additives. Examples of flavoring can comprise citrus, berry, mango, cherry, among other fruits. The additive can comprise additional compounds including at least one member selected from the group consisting of nicotine, caffeine, nutraceuticals, vitamins, and botanical extracts, such as rosemary, lavender, lemongrass, cannabinoids and cannabidiol (e.g., CBD and THC). Alternatively, or in addition to the additional compound, the beverage can comprise at least one fermented or distilled spirit, such as vodka, gin, rum, tequila, whiskey, among others.

“Stationary” refers to components of the packaging equipment that are affixed to a trailer. While the stationary components are affixed to the trailer, the components can be removed for repair or replacement. Stationary components can comprise processing components, such as, but not limited to, an electrical panel, power generator, chiller and air compressor, compressed air tank, air dryer, product tank, carbonation system, carbon dioxide storage tanks, carbon dioxide vaporizer, and preservative introduction system.

“Portable” refers to components of the packaging equipment that are intended to be removed from the trailer and replaced after usage. Portable components can comprise beverage packaging equipment including, but not limited to, a re-chiller, can filler and seamer, labeling machine, finished product pallet, pallet lift, de-palletizer and optionally a dosing apparatus for introducing an additional compound into the beverage. During storage and/or transportation, portable components are detachably engaged to the trailer to avoid undesirable movement, particularly during transportation.

“Trailer” refers to a trailer that is capable of being transported by a DOT Class A tractor. The trailer can be comprised of plurality of trailers, such as two trailers. If a plurality of trailers are employed the portable components will be placed in the rear trailer. The portable and stationary components are mobile and transported by the trailer to any suitable location.

Broadly, the instant invention relates to a self-contained trailer that is capable of preparing and packaging a beverage. For example, the self-contained trailer according to the present invention may blend beverage components to prepare a beverage and in turn package the prepared beverages. The invention relates to mobile beverage packaging equipment as well as methods for using the equipment for packaging beverages. The beverage is prepared using the stationary components of the trailer and the prepared beverage is packaged using the portable components of the trailer (after being removed from the trailer).

In one embodiment, the beverage comprises carbonated water, flavoring and optionally an additive. The amount of carbonated water can comprise 95% to about 99% of the beverage. The flavoring can vary as desired and can range from about 0.1% to about 0.5% of the beverage. The additional composition(s), if present, can range from about 0.01% to about 0.05%. If present, alcohol can range from greater than 0 to about 10%.

One embodiment of the invention relates to using the portable components for packaging beverages containing an infused composition wherein the activities associated with the infused composition including infusing into a beverage, packaging the infused beverage as well as storing packaged beverages containing the infused composition are all conducted within a defined area. In one aspect of this embodiment, the portable components are removed from the trailer and located within defined area comprising an enclosed and secured area, and then used for preparing and packaging beverages within that area (for example, beverages can be produced in accordance with Michigan code 333.27961; Sec. 11). In one aspect of this embodiment, the beverage comprises at least one infused composition. In one particular aspect of this embodiment, the trailer and attendant stationary components remain outside of the enclosed area or building, and the portable components are brought into the enclosed area or building for packaging the beverage containing an infused composition. In this particular aspect, all ingredients of the beverage (except for the infused composition) are combined using the stationary components, the prepared composition is conveyed to the portable components within the enclosed area for addition of the infused composition and packaging in order to produce the finished beverage. The beverage is stored within the enclosed area.

In one specific aspect of these embodiments, the total amount of additive to form an infused composition can vary including greater than 0 to about 10 mg, about 0.5 to about 7.5 mg and, in some cases about 1 to about 3 mg, per 250 ml of beverage. In another specific aspect of these embodiments, the total amount of the additive can range from about 0 to about 100 mg, about 2.5 to about 25 mg and, in some cases about 2.5 to about 5 mg, per 250 ml of beverage.

For some beverages, the presence of oxygen and, in particular, oxygen dissolved within the beverage, can have an undesired effect on taste, shelf-life, among other beverage characteristics. Without wishing to be bound by any theory or explanation, it is believed that by increasing the amount of dissolved carbon dioxide present in a beverage, it is possible to reduce the amount of dissolved oxygen present in a beverage. The amount of dissolved oxygen is preferably less than 2,000 ppb, less than about 1,500 ppb and, in some cases, less than about 1,000 ppb. The amount of dissolved carbon dioxide can range from greater than 2 volume percent, in some cases, greater than about 3.2 and typically about 3.2 to about 3.5 volume percent carbon dioxide. One embodiment of the invention relates to using an inventive trailer comprising a counterpressure can filler wherein the resultant beverage has improved amounts of dissolved carbon dioxide and oxygen (e.g., the amount of oxygen is reduced relative to the amount of carbon dioxide). The amount of carbon dioxide and oxygen can be determined by any suitable method, such as using an Anton Paar CboxQC analyzing system.

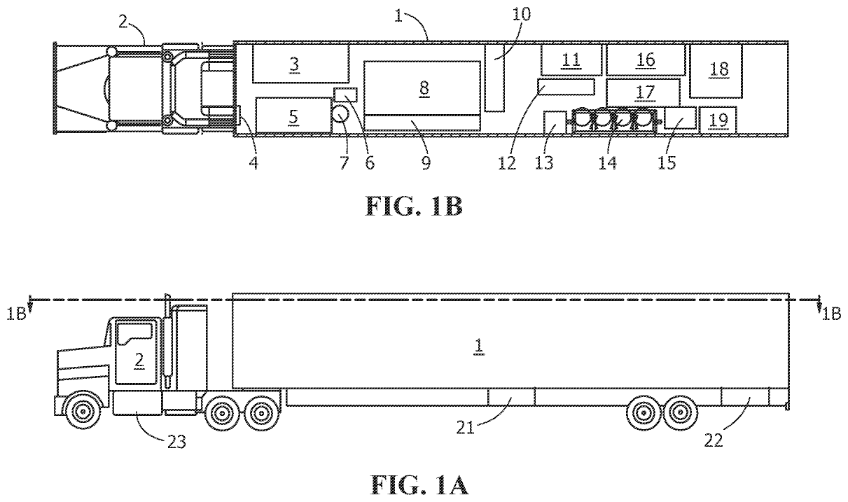

Reference is made to the drawings that illustrate certain embodiments of the disclosure. Referring now to FIGS. 1A and 1B, the trailer 1 comprises stationary and portable components. The trailer along with the stationary and portable components are mobile and transportable to desired locations by a tractor 2. Trailer 1 can be of any suitable length which complies with applicable federal, state and local laws and regulations (such as Pennsylvania Title 75, Chapter 49, 4923 (B.1). A typical trailer will be about 53 feet in length. The portable components are located towards the rear of the trailer to expedite their removal and subsequent storage. In one embodiment, the trailer comprises a tandem trailer arrangement and, in such an arrangement, the portable components are located in the rearward trailer. A lift gate (not shown) can be added if the trailer is transported to a location without a loading dock. If a relatively large volume of beverages are being produced, then two or more trailers can be transported to the production location.

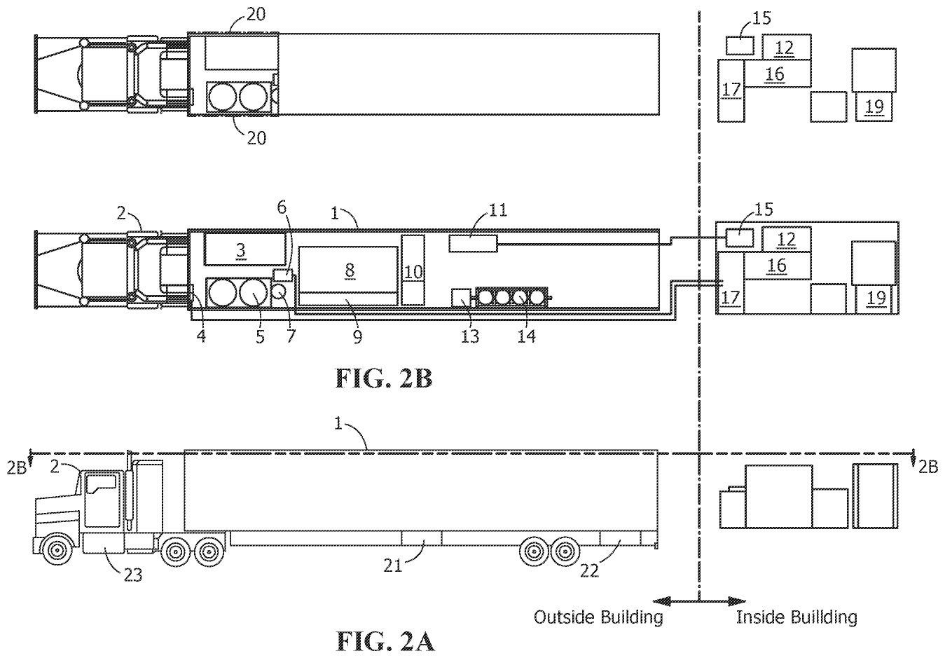

As shown in FIGS. 1B and 2B, stationary components on trailer 1 comprise an electrical panel 4, power generator 3, chiller and air compressor 5, compressed air tank 7, air dryer 6, product tank 8, carbonation system 10, liquid carbon dioxide storage tanks 14, carbon dioxide vaporizer 13, and preservative introduction system 11. While any suitable number of carbon dioxide storage tanks can be employed, the Figures show 4 such tanks. A platform or walkway 9 can be positioned along the product tank 8 in order to provide access to the stationary components. All components of the beverage are conveyed through the stationary components using sanitary food grade lines and fittings. The lines can be fabricated from any suitable material including fixed stainless steel and copper lines. While the stationary components can have any suitable relative position, the positioning shown in FIGS. 1A and B is effective for preparing a beverage that is packaged by the portable components.

As shown in FIGS. 1B and 2B, portable components on trailer 1 comprise the beverage packaging equipment including re-chiller 12, can filler and seamer 16, rinse tunnel 17, pallet lift 19, de-palletizer 18 and optionally an infusing or dosing apparatus 15 for introducing an additional compound into the beverage. Additional portable components can include a product labeling machine, conveyors for transporting unfilled packages (e.g., cans) and packaged beverages, and pallets for finished/packaged beverages. While the portable components can have any suitable relative position to each other on the trailer, the positioning shown in the FIGS. 1A and 1B is effective for transporting the portable components to a packaging location and FIGS. 2A and 2B show the portable components removed from trailer 1 while maintaining fluid communication with the stationary components of FIGS. 1A and 1B. All components of the beverage are conveyed through the portable components using sanitary food grade lines and fittings. The lines connecting the stationary components to the portable components and lines among the portable components can be fabricated from flexible materials including butyl rubber, EPDM rubber, and polyethylene. By using flexible line materials, the portable components can be removed from the trailer and positioned in a wide range of configurations and relative positions in order to accommodate the packaging location as well as comply with any state or local regulations related to packaging beverages. The length of the flexible line materials on the trailer will be relatively long in order to permit positioning the portable components to accommodate the packaging locations. If desired, the flexible lines can be disconnected and stored between packaging operations.

Trailer 1 can have any suitable exterior covering 20. Referring now to FIGS. 2A and 2B, preferably the covering comprises a slidable canopy which can be opened and moved along the length of the trailer in order to allow access to the trailer components. Once partially or completely opened, the trailer components can be accessed from the side of the trailer. At least partially opening the canopy in a manner sufficient to expose generator 3 and chiller/air compressor 5 enhances operation of these components by increasing heat exchange due to air flowing to and through these components.

In one embodiment of the invention, generator 3 includes a diesel engine. The generator on the trailer can include a diesel fuel reserve or, if desired, a diesel fuel tank 23 on tractor 2 can be connected to the generator 3. In another embodiment of the invention, the power is provided via the tractor transporting the trailer or another auxiliary power unit.

A coolant or refrigerant is employed by chiller 5. While any suitable coolant or refrigerant can be employed by chiller 5, in one embodiment the coolant comprises glycol. Trailer 1 can include a coolant storage tank 21. Coolant is stored while not in usage and, as necessary, removed or replenished via tank 21.

In one embodiment, trailer 1 includes a self-contained drainage system. The drainage system can comprise openings or mesh (not shown) defined in the floor of the trailer. These openings permit any fluid released on the trailer to drain onto a sub-floor of the trailer and in turn be collected in a storage tank 22. The contents collected in tank 22 can be emptied and handled in an environmentally acceptable manner. For example only, the components on the trailer may be washed and the washing liquid drains through the openings and is collected in tank 22.

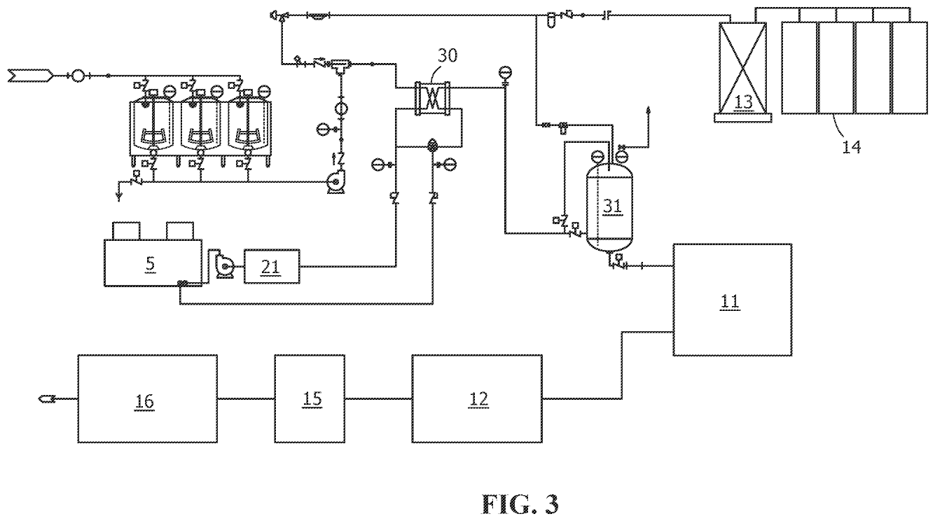

Referring now to FIG. 3, FIG. 3 is a schematic drawing that shows the flow of materials for preparing and packaging a beverage. Food grade water for preparing the beverages is supplied to product tanks 8. Alternate embodiments employ water treatment equipment including, but not limited to, at least one of a carbon filtration system, a water softener system, a reverse osmosis filtration or deionized water system. In addition to water treatment, a further alternate embodiment includes a de-aerating system to remove dissolved gasses from the water. Examples of such de-aerating systems include membrane de-aeration, vacuum de-aeration, or sparging gas de-aeration. While FIG. 3 shows using three tanks, any suitable number of tanks can be employed. Water can be added to the product tanks 8 before being transported on the trailer, or water can be introduced, as needed, at the beverage preparation and packaging location. A flow meter can be employed to measure the precise mass or volume of water added to the tanks. Examples of suitable flow meters include magnetic and Coriolis mass flow meters. In addition, the tank can be fitted with inert gas purging nozzles that reduce exposure of the liquid to uncontrolled gasses that may alter or deteriorate the product. Purge gasses include, but are not limited to, nitrogen and carbon dioxide. Flavorants and other beverage components (other than carbon dioxide and any infused additional compounds), can be added to product tanks 8 and blended. Product tanks 8 include bottom drains as well as level sensors for controlling the flow of material into and from the product tanks.

An aqueous composition from tanks 8 is pumped to a heat exchanger 30 (e.g., supplied by Mueller AccuTemp Plate Heat Exchanger), for removing heat from the aqueous composition. A closed loop supplies coolant to heat exchanger 30 such that the aqueous composition cannot directly contact the coolant. Coolant (e.g., glycol) is pumped from storage tank 21 to chiller 5 and to heat exchanger 30 in order to reduce the temperature of the aqueous composition as the aqueous composition flows through heat exchanger 30. The closed coolant loop also contacts a heat exchanger on carbon dioxide vaporizer 13 thereby releasing heat to the vaporizer in order to enhance vaporization of liquid carbon dioxide as well as to remove heat from the coolant. The vaporizer can operate by passive heat exchange with the environment or could be active using electricity, steam, or any other suitable heat transfer method.

The chilled aqueous composition exits heat exchanger 30. Liquified carbon dioxide from tanks 14 is introduced to vaporizer 13 and converted into gaseous carbon dioxide. The chilled aqueous composition exiting the heat exchanger is combined with vaporized carbon dioxide in accumulation tank 31 thereby producing a carbonated composition.

The carbonated composition is introduced to a preservative introduction system 11. The preservative introduction system provides a food grade preservative. The carbonated and preserved composition leaves the stationary components of the trailer and enters the portable components for further processing (the portable components which were previously removed and positioned appropriately for processing). The carbonated and preserved composition is passed through a heat exchanger or re-chiller 12 to reduce the temperature of the composition.

The chilled carbonated and preserved composition is passed through an optional apparatus 15 for adding an infused additional compound. Apparatus 15 adds an infusion in predetermined amounts based upon flow rates or volumetric measurements. The composition is then sent to a can filler and seamer 16 thereby providing the final packaged beverage. The beverage can be handled in any suitable manner, such as washing, labeling, and palletizing.

The coolant circulation loop can be operated under any suitable conditions. Examples of suitable operating conditions include a flow rate of greater than 0 to about 10 gpm, a temperature of about 25 to 36 degrees F. and a pressure of greater than 0 to about 10 psi.

Compositions used for preparing the beverage can be handled under any suitable conditions. Examples of suitable conditions include a flow rate of greater than 0 to about 10 gpm, a temperature of about 30 to 35 degrees F. and a pressure of about 10 to 40 psi.

After vaporization, carbon dioxide is provided to the carbonator 10 as a function of the aqueous composition flow rate. The amount of vaporized carbon dioxide is calculated by multiplying the product flow rate in CFM by 0.3-0.7 to determine the CO₂ flow rate in CFM. The pressure of the vaporized carbon dioxide ranges from about 10 to about 90 psi.

Compressed air is produced by chiller and compressor 5. Compressed air is employed to operate mechanical systems of the stationary and portable components including can filler and sealer 16 and rinse tunnel/labeler 17. While any suitable pressure and flow rate can be used, examples of suitable pressure and flow rates are about 50 to about 150 psi and greater than 0 to about 10 CFM. Compressed air can be delivered to the appropriate stationary components via fixed lines and to the portable components via flexible (and if desired retractable) lines.

Generator 3 provides electric power for all components using electricity. Power from generator 3 is provided to the components at any suitable voltage and phases via electrical panel 4. While any suitable power can be employed, the power can be delivered as 208 v/3 phase, 120 v/single phase and as 120 v/3 phase. Wattage can range from about 20 to about 80 KW. Electrical power can be delivered to the appropriate stationary components via fixed lines and to the portable components via flexible (and, if desired, retractable) lines.

While the disclosure emphasizes using carbon dioxide to prepare carbonated beverages, other food grade gases can be employed, such as nitrogen.

An alternate embodiment of the invention could include a heating system for operating in environments below 32 dF. An example heating solution would be a 174,900 BtuH oil or kerosene indirect fired heater manufactured by HEAT WAGON. Alternate heating methods could be employed, for example electric heating panels or propane.

While any suitable components can be employed in connection with this invention, examples of suitable commercially available equipment components include:
1) power generator: Tier 4 Diesel Powered supplied by Wacker Neuson,
2) chiller and air compressor: Carrier and Sullivan Palletek,
3) compressed air tank: Sullivan Palletek,
4) air dryer Sullivan Palletek,
5) carbonation system: Control System supplied by Allen Bradley,
6) carbon dioxide storage tanks: food grade liquid carbon dioxide supplied by Roberts,
7) carbon dioxide vaporizer: supplied by VaporMan,
8) preservative introduction system: supplied by Lanxess
9) re-chiller: G&D Chillers,
10) can filler and seamer: counter-pressure system supplied by Codi Manufacturing,
11) labeling machine: Pack Leader.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. Mobile beverage preparation and packaging equipment comprising a trailer for transporting the equipment, at least one stationary component and at least one portable component wherein the stationary component is affixed to the trailer and the at least one portable component are removable from the trailer.

2. The equipment of claim 1 wherein the trailer includes a slidable canopy covering the stationary and portable components.

3. The equipment of claim 1 wherein the stationary components comprise at least one member selected from the group consisting of an electrical panel, power generator, chiller and air compressor, product tank, carbonation system, and carbon dioxide storage tanks.

4. The equipment of claim 1 wherein the portable components comprise at least one of can filler and seamer and a dosing apparatus for introducing at least one additive into the beverage.

5. The equipment of claim 3 wherein the stationary components are arranged and disposed to prepare the beverage.

6. The equipment of claim 4 wherein the portable components are arranged and disposed to package the beverage.

7. The equipment of claim 1 wherein the beverage, electricity and compressed air are supplied from at least one of the stationary components to at least one of the portable components.

8. The equipment of claim 7 wherein the beverage, electricity and compressed air are supplied via flexible conduits.

9. A method for preparing and packaging carbonated beverages comprising:
providing mobile beverage preparation and packaging equipment comprising a trailer for transporting the equipment, at least one stationary component and at least one portable component wherein the stationary component is affixed to the trailer and the at least one portable component is removable from the trailer,
transporting the trailer to a predetermined location,
removing the portable components from the trailer,
preparing the beverage using the stationary components,
transferring the beverage to the portable components, and;
packaging the beverage using the portable components.

10. The method of claim 9 further comprising adding a preservative to the prepared beverage.

11. The method of claim 9 further comprising adding at least one additive to the beverage after removing the portable components and before packaging the beverage.

12. The method of claim 9 further comprising removing the portable components and positioning the portable components within a defined enclosed location that is different than the predetermined location of the trailer.

13. The method of claim 11 wherein the additive comprises at least one infused compound.

14. The method of claim 9 wherein the portable component comprises a counter pressure can filler.

15. The method of claim 9 herein the beverage comprises less than 2,000 ppb oxygen.

16. The method of claim 9 wherein the beverage comprises greater than 2 volume percent carbon dioxide.

17. A mobile beverage preparation and packaging apparatus comprising:
a trailer for transporting beverage preparation and packaging equipment;
wherein the equipment comprises a plurality of components and wherein the beverage preparation equipment is affixed to the trailer and the beverage packaging equipment is detachably engaged to the trailer.
